(19) United States
(12) Patent Application Publication
(10) Pub. No.: US 2002/0130444 A1
(43) Pub. Date: Sep. 19, 2002

(54) Post cure hardening of siloxane stamps for microcontact printing

(76) Inventor: Gareth Hougham, Ossining, NY (US)

Correspondence Address: Thomas A. Beck, 26 Rockledge Lane, New Milford, CT, 06776, US

(21) Appl. No.: 09/809,440

(22) Filed: Mar. 15, 2001

(51) Int. Cl. B29C 35/02; B29C 45/00; B29C 71/02

(52) U.S. Cl. 264/519

(57) ABSTRACT

Microcontact printing stamp which achieves both the required dimensional integrity for pattern faithfulness and desired mechanical properties, primarily high elastic modulus. With vinyl addition-type siloxane precursor mixtures, where crosslinking (curing) can take place at either room temperature or higher temperature, a two-step cure produces the desired combination of properties. The article is cured at room temperature for an extended period and then cured at a higher temperature of about 60° C. The resulting stamp has desirable properties.

### FIELD OF THE INVENTION

This invention relates to the formation of microcontact printing stamps with a minimum degree of pattern distortion and with mechanical properties suitable for printing.

### BACKGROUND OF THE INVENTION

By way of illustration, a reference such as Siloxane Polymers for High-Resolution, High-Accuracy Soft Lithography, B. Michel, et.al. Macromolecules 1999, teaches that with microcontact printing, two stamp parameters are of critical importance; and Features of Gold Having Micrometer to Centimeter Dimensions Can Be Formed Through a Combination of Stamping with an Elastomeric Stamp and an Alkane Thiol Ink, Followed by Chemical Etching by Amit Kumar and George Whitesides, Appl. Phys. Lett. 63 (14) Oct. 4, 1993.

First, the pattern fabricated onto the stamp should faithfully represent the desired pattern intended to be printed. While obvious, the extraordinary detail conveyed with microcontact printing makes this faithful representation easier to state as a goal than to realize in practice.

Second, the stamp, once made, must have mechanical properties, such as elastic modulus, that allow handling during printing, and minimum additional distortion from the stresses incurred during printing contact. While it is possible to do either separately, it has proven to be a severe fabrication challenge to achieve both simultaneously.

### SUMMARY OF THE INVENTION

The present invention comprises a simple technique in the field of microcontact printing stamps to achieve both the required dimensional integrity for pattern faithfulness and desired mechanical properties, primarily high elastic modulus. It teaches that with the vinyl addition type siloxane precursor mixtures (and others), where crosslinking (curing) can take place at either room temperature or higher temperature, that a two-step cure produces the desired combination of properties.

The first step is a room temperature cure, since generally room temperature is the condition at which the stamp will be ultimately used. The stamp is allowed to crosslink at room temperature for some period, for example one week. During this period of time, the stamp crosslinks and fixes the overall stamp geometry and the printing pattern.

After this curing step is completed, the stamp is brought to a higher temperature, in the vicinity of 60° C., at which temperature a further cure continues thus attaining a higher elastic modulus. Upon cooling back to room temperature, the original pattern is restored without distortion and the stamp has the desired higher modulus.

### BRIEF DESCRIPTION OF THE DRAWINGS

FIG. 1 depicts the general process of microcontact printing stamp fabrication showing the most common method of application and the printing of alkane thiol self-assembled monolayers (SAMs) on gold as etch resist.

FIG. 2 shows details of structure and standard process for stamp fabrication including mold housing, position of “master” in mold, injection of elastomer reactive mix, and final stamp separation.

FIG. 3 shows a schematic of the two-step curing method process disclosed herein with a long-duration, substantially room-temperature cure followed by a high temperature hardening step.

FIG. 4A depicts the silicone curing systems.

FIG. 5 depicts the structure of silicone monomers and terminators suitable for forming siloxanes.

### DETAILED DESCRIPTION OF THE INVENTION

Standard Stamp Fabrication Method:

A brief description of the now-standard method for making microcontact printing stamps will allow better understanding of the herein disclosed post-cure hardening process.

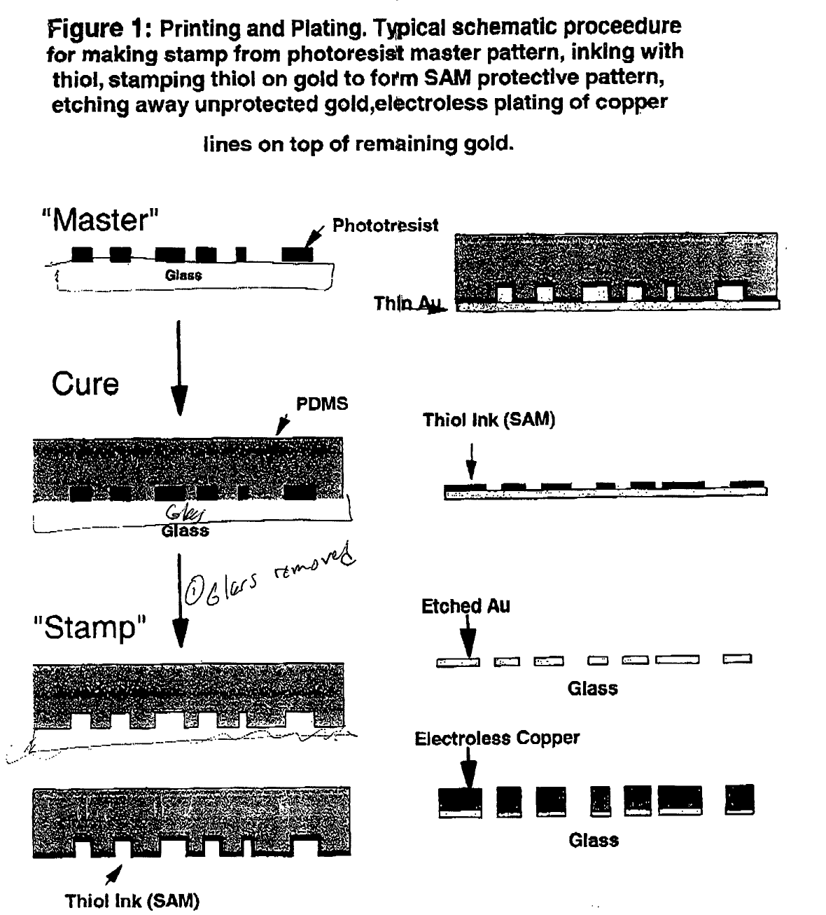

In FIG. 1, a typical illustrative microcontact printing sequence is shown. The microcontact printing stamp is made by first forming a master pattern in photoresist on glass. Then a reactive rubber mix, (e.g., a 2-part siloxane) is poured into the master and allowed to cure. After curing, the master is removed revealing a stamp pattern in relief. Then, to perform the stamping “print and plate” process, the stamp is inked with a thiol functional alkane. The stamp is then brought into contact with a gold-coated substrate, and thiol ink is transferred in the desired pattern. This forms a SAM layer which protects the gold during a gold etch. The SAM layer is then removed and copper is deposited on top of the remaining gold to thicken the metallic path to form high quality conducting lines.

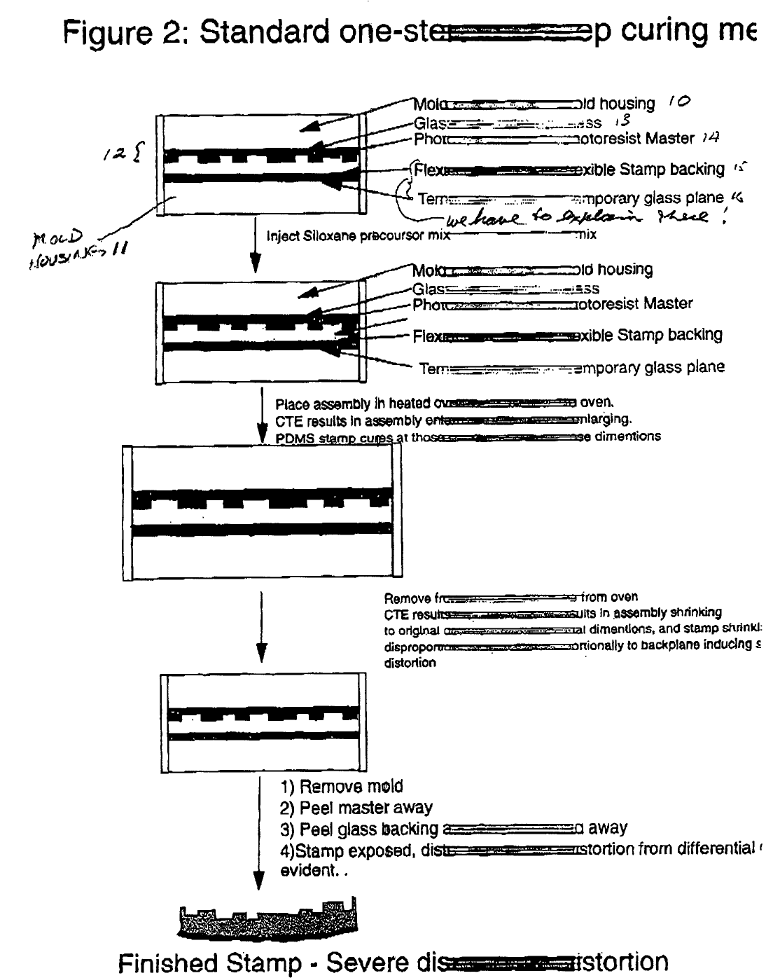

The standard method of forming the stamp itself is closely related to injection molding. Referring to FIG. 2, a mold housing typically consisting of a machined metal casing 10 and 11 accommodates a master pattern 12 on one internal face and a flexible back plane on the other. The master is generally glass 13 with patterned photoresist 14 in the negative pattern desired for the stamp relief pattern. The back plane will ultimately become an integral part of the stamp, and has been pretreated with an adhesion promoter. The master and backplane are held in place on opposite extreme faces inside the mold housing, and a precise gap between them is established by appropriate choice of spacers. After the master and backplane have been positioned in the mold housing, and the mold has been bolted closed, a freshly mixed and degassed two-part siloxane reactive mixture is injected under pressure into the mold. Once filling is complete, the fill hole and vent are capped and the entire mold assembly, with its liquid reactive siloxane mixture contained, is loaded into an oven. The oven can either be preheated to some temperature, or ramped to some temperature. Typically temperatures of 60° C. to 120° C. are used. After some time, typically from 1 hour to 24 hours at a temperature sufficient to ensure full cure, the mold is allowed to cool to room temperature. The bolts undone, and one half of the casing is removed to expose a sandwich type structure consisting of backplane, siloxane, and master.

The stamp with affixed backplane is separated from the photoresist/glass master to complete the process.

A series of sources for severe pattern distortion in this standard process result by virtue of the curing of the siloxane at higher temperatures than the final use temperature (room temperature). One reason for the distortion noted above is that each component of the mold, including the master with glass and photoresist, flexible backplane, spacers, and mold housing expands with temperature changes according to the CTE of each. Thus, each component of the structure, being made of a different material with a different coefficient of expansion, expands disproportionally relative to each other, and to the original intended pattern. These will be the dimensions in place at the time of curing when the siloxane hardens into a stamp, and the pattern becomes fixed.

At this point, with the oven hot and after sufficient time for curing, the stamp possesses a pattern dimension that is related to the original master pattern according to the composite CTE of the master glass and photoresist. As the glass and photoresist will have expanded more or less uniformly, the stamp pattern will differ from the original in a relatively predictable way, which would be able to be reasonably compensated for by choice of an appropriately scaled master pattern to begin with. This sequence would produce a useful product if this were the end of the fabrication process, but it is not. Before the stamp is separated from the mold, the entire assembly must first be cooled down. During cooling, the master will shrink according to its moderate CTE (maybe 20 to 40 ppm). The stamp itself will shrink very significantly with a CTE of about 500 to 800 ppm, and the affixed backplane will shrink with a CTE of around 5 to 50 ppm, depending on the choice of material. Invar is typically used. It is this differential CTE between the permanently affixed backplane and the stamp that causes a complex pattern distortion that is sought to be avoided.

Disclosed New Stamp Fabrication Method:

The new two-step curing process of the present invention disclosed herein eliminates, or significantly mitigates, the typically observed pattern distortion between master and final stamp patterns found in the prior art.

In accordance with the present invention, a pre-injection mold, master, backplane, spacers, and other associated fixtures, are assembled in the same way as in the standard process.

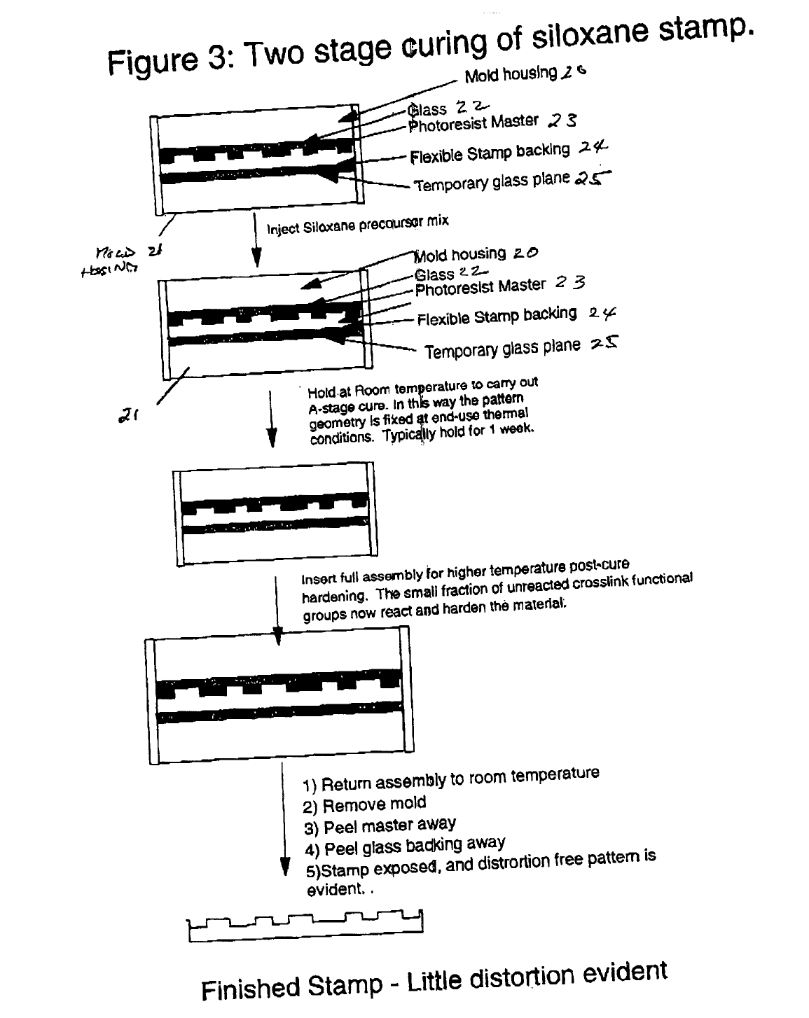

More particularly, referring to FIG. 3 of the drawings, the assembly used in accordance with the present invention comprises mold housings 20, 21, glass sheet 22, photoresist master 23, flexible stamp backing 24, and temporary glass pane 25. The injection of the mixed reactive liquid siloxane precoursor is also carried out in the same fashion. The process differs in subsequent steps.

The stamp compositions used in accordance with the present invention is polydimethylsiloxane.

The repeating unit:

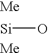

is referred to as a D unit, while the termination unit (Me₃SiO), the trimethylsiloxy group is referred to an M unit. Silicones are both linear and branched.

A branched silicone can have the branch points:

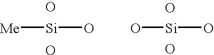

referred to generally as T groups and Q groups.

A variety of groups, including phenyl, vinyl and hydrogen can substitute for the methyl group in a silicone. This is significant inasmuch as the substitution, branching and molecular weight of a silicone polymer will dictate the method by which the silicone of the present invention will be accomplished.

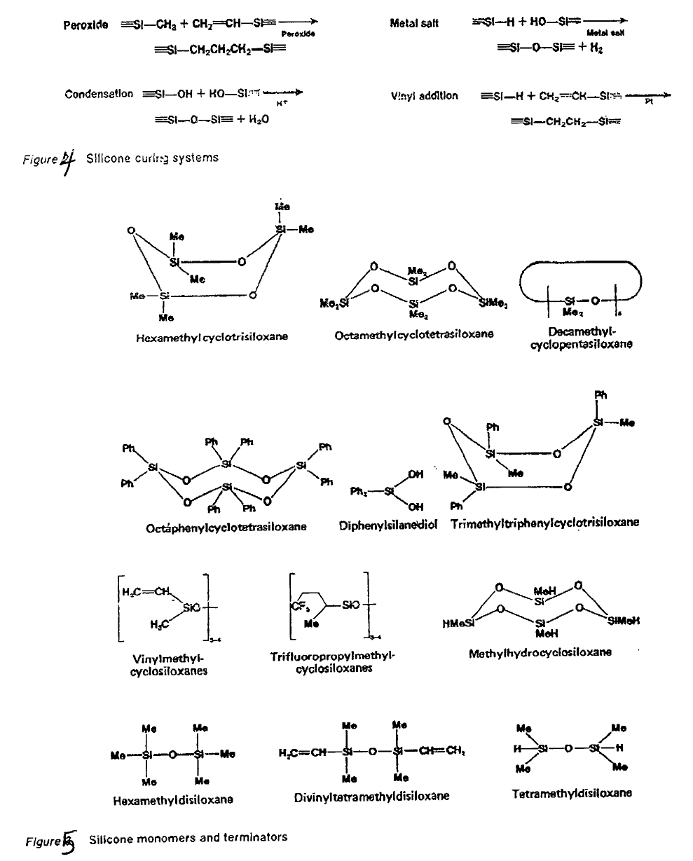

There are four general methods used by which the curing or cross-linking of the instant silicones are made. The four methods are depicted schematically in FIG. 4. In high temperature vulcanizing (HTV) systems, polymers containing methyl or vinyl groups are cross-linked with peroxides, or their equivalents. In room-temperature vulcanizing (RTV) systems, two cure methods are used. Silanols are condensed with a moisture-sensitive silane cross-linker; or a metal salt catalyzes the reaction between silicon hydrides and silanols. The latter reaction liberates hydrogen as a by-product. Vinyl addition systems, in which a platinum complex catalyzes the addition of silicon hydrides to vinyl-substituted silanes, was initially used in low-temperature vulcanizing (LTV) systems but has been extended to RTVs and HTVs.

While the elastomer preferably used in accordance with the present invention is a siloxane, (more accurately a siloxane precursor mix) more preferably a vinyl addition type siloxane two component mixtures such as Sylgard 184, from Dow Corning. FIG. 5 depicts silicone monomers and terminators that can be utilized alone or in combination as starting materials in the present invention. These include siloxane system contains moieties selected from the group consisting consisting of hexamethylcyclotrisiloxane, hexamethylcyclotrisiloxane, octamethylcyclotrisiloxane, decamethylcyclotrisiloxane, octaphenylcyclotetrasiloxane, diphenylsilanediol, trimethyltriphenylcyclotrisiloxane, vinylmethylcyclosiloxanes, trifluoropropylmethylcyclosiloxanes, methylhydrocyclosiloxane, hexamethyldisiloxane, divinyltetramethyldisiloxane, tetramethyldisiloxane.

Other polymeric materials may be used such as epoxy systems, acrylate systems, polyurethane systems, polyphosphazine systems and styrene copolymer systems. These examples are presented by way of illustration and not by way of limitation.

With siloxane prepared from a material(s) such as depicted in FIG. 5 freshly injected into the mold the entire mold assembly is set aside in an undisturbed location held uniformly at the final use temperature. This temperature is anticipated to be usually room temperature to effect the A-stage cure. As a result of the A-stage curing, the pattern geometry of the article is fixed at end-use thermal conditions.

The curing environment should be held at that temperature ideally within one tenth of one degree. This specification is dictated by the extreme target for registration of different layers of microelectronic wiring and components which will be fabricated by microcontact printing, and by the very high CTE value of siloxane and other elastomer materials. This registration in some cases may need to be within a couple microns over distances of 15 inches or more. It is advantageous, though not always necessary, to seal the mold in a watertight flexible bag and immerse the complete mold assembly into a precision water bath which is thermostatically controlled.

The duration for this A-stage curing will differ depending on the exact reactive mix used. The most preferred convenient material used is Sylgard 184 siloxane, which is a commercial vinyl-addition type siloxane consisting of two main components: A.) Polydimethyl siloxane oligomers with silyl vinyl groups (—Si—C═CH₂); B.) Polydimethyl siloxane oligomers with silicon hydride groups having the formula:

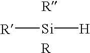

wherein R, R′, R″ are methyl and phenyl, vinyl and hydrogen, which will react with the vinyl groups in the presence of a catalyst to cross-link into a rubber material.

Use of the preferred material this would require about 4 to 7 days for successful completion of the A-stage cure at room temperature. After the duration of the first cure, the entire full mold assembly is brought to a uniform higher temperature for post cure hardening. In this stage the small fraction of unreacted crosslink functional groups in the material now react and harden the article.

The optimum high temperature for hardening is dependent on the pattern and overall stamp geometry and nature of the ink and substrate, but is usually between 50 and 120° C. Once held at this temperature for a period sufficient to achieve the final reactive crosslinking and increase in modulus or hardness, the mold is then cooled back to room temperature.

The stamp is separated from the mold and is then ready for use. The master is peeled away and the stamp is exposed and the distortion-free pattern is evident.

This post-cure hardening is the result of an unexpected ability of the stamp material to harden in a post-cure high temperature step. Initial expectations were that no hardening would occur because the majority of crosslink functionality would have been consumed during the low temperature cure. Initial experiments indeed appeared to confirm that expectation, yet a more careful investigation where the bulk modulus was measured before and after the post-cure heating indeed showed that the modulus was brought to the same or nearly the same higher value as achieved by curing to that higher temperature right from the start. This finding was confirmed to be repeatable.

Thus, the invention separates the curing of the siloxane (or other material) stamp into two stages. The first stage accomplishes the vast majority of chemical crosslinking while constrained by the master pattern at the intended pattern dimensions.

The second stage hardens the material without inducing significant further permanent geometrical changes to the pattern. Thus, both necessary stamp requirements, which are usually mutually exclusive, are met simultaneously by this method.

Thus, while there have been shown, described and pointed out fundamental novel features of the invention as applied to currently preferred embodiments thereof, it will be understood that various omissions and substitutions and changes in the form and details of the method and apparatus illustrated, and in their operation, may be made by those skilled in the art without departing from the spirit of the invention. In addition it is to be understood that the drawings are not necessarily drawn to scale but that they are merely conceptual in nature. It is the intention, therefore, to be limited only as indicated by the scope of the claims appended herewith.

What I claim and desire to protect by Letters Patent is

1. A method of making a stamp for microcontact printing, comprising:
injection molding an elastomer reactive mix into a mold;
substantially curing and crosslinking said elastomer reactive mix in said mold at substantially the end use temperature of a stamp to be formed from said elastomer reactive mix;
followed by a subsequent cure of said elastomer reactive mix at a temperature higher than said substantial end use temperature sufficient to harden said elastomer reactive mix to a desired elastic modulus.

2. The method of making a stamp for microcontact printing defined in claim 1 wherein said elastomer reactive material is a siloxane

3. The method of making a stamp for microcontact printing defined in claim 2 wherein said said siloxane is cured to fix its geometry while at or near the intended final use temperature, followed by a higher temperature step to harden said siloxane, without substantially inducing geometry changes to said stamp and pattern.

4. The method of making a stamp for microcontact printing defined in claim 2 wherein said siloxane elastomer mix is a vinyl addition-type siloxane two component mixture.

5. The method of making a stamp for microcontact printing defined in claim 2 wherein said siloxane is room temperature curable.

6. The method of making a stamp for microcontact printing defined in claim 1 wherein said elastomer reactive material is selected from the group consisting of siloxane systems, epoxy systems, acrylate systems, polyurethane systems, polyphosphazine systems, styrene copolymers.

7. A method of manufacturing a flat panel display where TFT and wiring dimensions contained therein are microscopically small and registration of subsequent layers of such display is within microns over many inches, using the methoid defined in claim 1.

8. A method of manufacturing a microelectronic pattern using the method defined in claim 1.

9. The method of making a stamp for microcontact printing as defined in claim 6 wherein said siloxane system contains moieties selected from the group consisting of hexamethylcyclotrisiloxane, octamethylcyclotrisiloxane, decamethylcyclotrisiloxane, octaphenylcyclotetrasiloxane, diphenylsilanediol, trimethyltriphenylcyclotrisiloxane, vinylmethylcyclosiloxanes, trifluoropropylmethylcyclosiloxanes, methylhydrocyclosiloxane, hexamethyldisiloxane, divinyltetramethyldisiloxane, tetramethyldisiloxane.

10. The method of making a stamp for microcontact printing as defined in claim 6 wherein said siloxane system comprises polydimethyl siloxane oligomers with silyl vinyl groups (—Si—C═CH₂. and polydimethyl siloxane oligomers with silicon hydride groups having the formula: 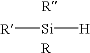
wherein R, R′, R″ are methyl and phenyl, vinyl and hydrogen, which will react with the vinyl groups in the presence of a catalyst to cross-link into a rubber material.
